(19) United States
(12) Patent Application Publication
(10) Pub. No.: US 2014/0183925 A1
(43) Pub. Date: Jul. 3, 2014

(54) VEHICLE SEAT TRIM CLOSEOUT SLIDE SYSTEM

(71) Applicant: LEAR CORPORATION, Southfield, MI (US)

(72) Inventors: James CLAUSER, Oakland Township, MI (US); William PARUSZKIEWICZ, Clinton Township, MI (US); Paul S. Severinski, Brownstown, MI (US); Thomas A. Welch, SR., Ortonville, MI (US)

(73) Assignee: LEAR CORPORATION, Southfield, MI (US)

(21) Appl. No.: 14/138,209

(22) Filed: Dec. 23, 2013

Related U.S. Application Data
(60) Provisional application No. 61/747,688, filed on Dec. 31, 2012.

(51) Int. Cl. B60N 2/70; B60N 2/72

(52) U.S. Cl. CPC B60N 2/7005; B60N 2/72
USPC 297/452.38; 24/460

(57) ABSTRACT

A trim cover closeout system for securing adjoining trim cover portions on a vehicle component such as a seat at an opening between the trim cover portions, the system includes first and second trim edge attachment elements each having a mounting surface adapted to be secured to the edge of one of the trim cover portions and it an attachment portion including an outwardly protruding surface, and any longer closure element configured to extend over substantially the entire length of the opening, wherein the closure element may be slidably positioned over the attachment elements to secure the first and second attachment elements and, thereby, the edges of the adjoining trim cover portions to each other to close the opening. A vehicle seat assembly including the trim cover closeout system is also disclosed.

### CROSS-REFERENCE TO RELATED APPLICATIONS

This application claims the benefit of U.S. provisional application Ser. No. 61/747,688; filed Dec. 31, 2012, the disclosure of which is hereby incorporated in its entirety by reference herein.

### TECHNICAL FIELD

The invention relates to a seat trim closure system for a vehicle seat.

### BACKGROUND

Trim covers for seats comprise a plurality of multi-layer panels of flexible material including an exterior cloth, vinyl or leather panel and, optionally, one or more insulative/protective backing layers. When installed over the seat foam pads and frame, the panels are typically sewn together so as to completely cover the seat.

In some instances, openings are left in the otherwise sewn trim cover panel seams to provide access for insertion and/or installation of seat components, such as side impact airbag assemblies, or to facilitate the installation of the trim cover, during seat assembly. It is desirable to quickly and easily close these openings in the trim cover after the components have been installed through the opening. It is also desirable that any closure result in a seam which is functionally and aesthetically similar to the other trim cover seams on the seat.

### SUMMARY

The disclosed trim cover closeout slide system provides a quick, easy-to-install closure for an opening in seat or other automotive component trim panels. The system includes a pair of trim edge attachment elements one of each of which are attached at their proximal edges, respectively, to the edges of two adjoining trim cover portions, and an elongate closure element configured to extend over substantially the entire length of the opening, wherein the closure element is adapted be slidably positioned over the distal edge of the attachment elements to secure the elements and, thereby, the edges of the adjoining trim cover portions, together in a manner which results in the exterior surface of the adjoining trim cover portions having the same appearance as the other trim cover seams.

In a disclosed embodiment, the trim edge attachment elements comprise elongate resilient retainer strips, each of which may be attached (by sewing or other suitable adhesive) to the edges of the trim cover sections along the length of the opening. Each of the retainer strips includes an arrowhead portion which is outwardly inclined from the interior major surface of the trim panel.

In a disclosed embodiment, the closure element comprises an elongate resilient channel which is configured to be slidably positioned over substantially the entire length of retainer strips to retain the retainer strips and trim panel edges together within the channel and, thus, close the open edges of the trim covers. The disclosed channel includes a generally planar base portion and a pair of opposed, spaced-apart sidewalls, each of said sidewalls extending in a generally transverse direction from the base portion at its proximal edge, thereby forming a generally u-shaped cross-section. Each of the sidewalls includes an upper wall portion which curls inward from the sidewall at its distal edge, into the space between the pair of sidewalls. The channel can be positioned by an assembler into the interior of the seat (through another access opening in the trim cover) and slidably positioned over the retainer strips to complete the closure once access to the inside area of the seat adjacent the opening is no longer required.

In a disclosed embodiment, the first and second retainer strips may be slidably positioned relative to the channel such that the first and second retainer strips and the trim cover edges to which the first and second retainer strips are attached are sandwiched between the sidewalls of the channel. The attachment portion of the first retainer strip interacts with the distal end of the first of one of the sidewalls, and the attachment portion of the second retainer strip interacts with the distal end of the other of said sidewalls to thereafter prevent unintended removal of either of the trim cover edges from the channel, thereby securing the edges of the adjoining trim cover portions to each other. The channel may be intentionally removed (to, for example, re-open the opening between the trim panels) by sliding the channel in the direction parallel to the major axis of the retainer strips.

Another disclosed embodiment includes a vehicle seat assembly having a lower seat cushion assembly and the seat back cushion assembly, each including one or more foam cushions and a skeletal frame, and a trim cover comprising a number of trim panels each of which are joined together at one or more seams to form the completed exterior cover for the seat. One or more openings are defined at the edges of adjoining trim cover panels, which edges are otherwise joined together. A trim cover closeout system is provided for securing the adjoining trim cover portions at one of the openings, and includes a pair of trim edge attachment elements, one of each of which are attached at their proximal edges, respectively, to the edges of two adjoining trim cover portions at the opening, and an elongate closure element configured to extend over substantially the entire length of the opening, wherein the closure element is adapted be slidably positioned over the distal edge of the attachment elements to secure the elements and, thereby, the edges of the adjoining trim cover portions, together, to close the opening during completion of the seat assembly.

### BRIEF DESCRIPTION OF THE DRAWINGS

FIG. 1 is a perspective view of a vehicle seat which might include the disclosed trim cover closeout slide system;

FIG. 2 is a depiction of two adjacent trim cover panels having an open seam to which the disclosed retainer strips are attached;

FIG. 3 is a schematic end view of the trim closeout slide system installed on two seat trim panels;

FIG. 4 is an end view depiction of the trim closeout channel installed over adjacent trim cover edges; and

FIG. 5 is an exterior facing view of the seam between two adjacent trim covers closed after installation of the slide system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

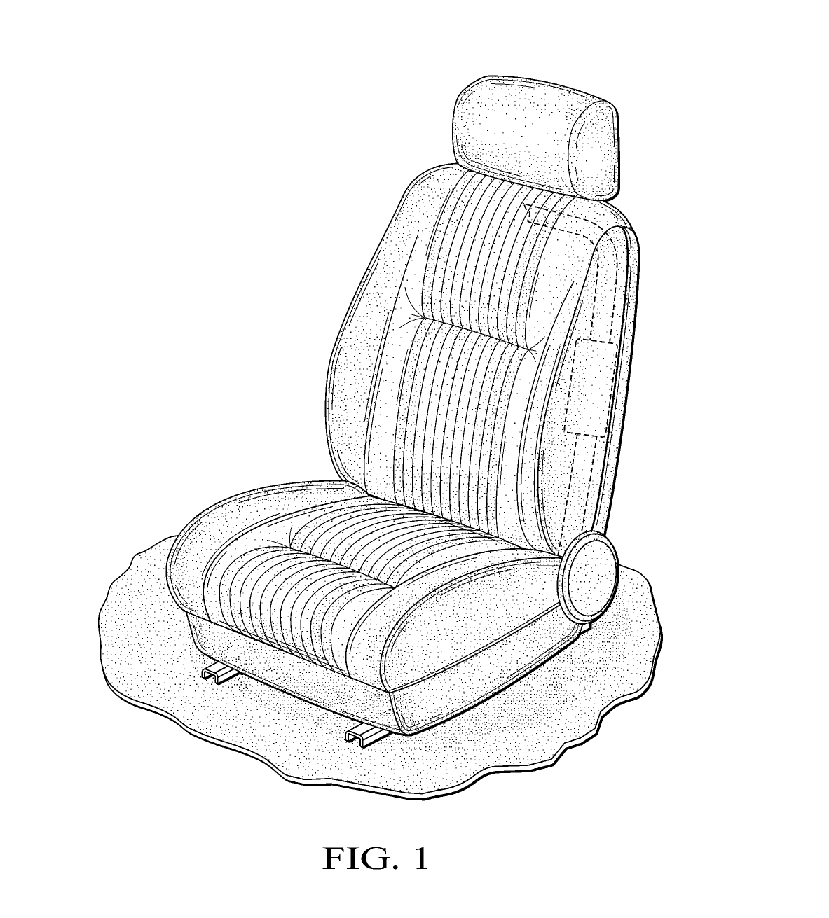

Referring to FIG. 1, the disclosed trim cover closeout slide system is typically employed on a vehicle seat 10 which includes a lower seat cushion assembly 12 and a seat back cushion assembly 14 attached to the lower seat cushion assembly 12, such as by one or more recliner mechanisms. The seat back and/or seat cushion typically include a rigid skeletal frame 16 and various components mounted on the frame and/or within the molded cushions. For example, a side impact airbag (SIAB) module 18 is often mounted on the frame at the outboard side of the seat back 14.

The vehicle seat 10 typically includes a seat trim cover comprising a number of exterior trim panels of cloth, vinyl, or leather material, or combinations thereof, each of which are sewn or otherwise joined together at one or more seams 20 to form a smooth exterior covering for the completed seat. The trim panels may also include one or more insulative or protective backing layers.

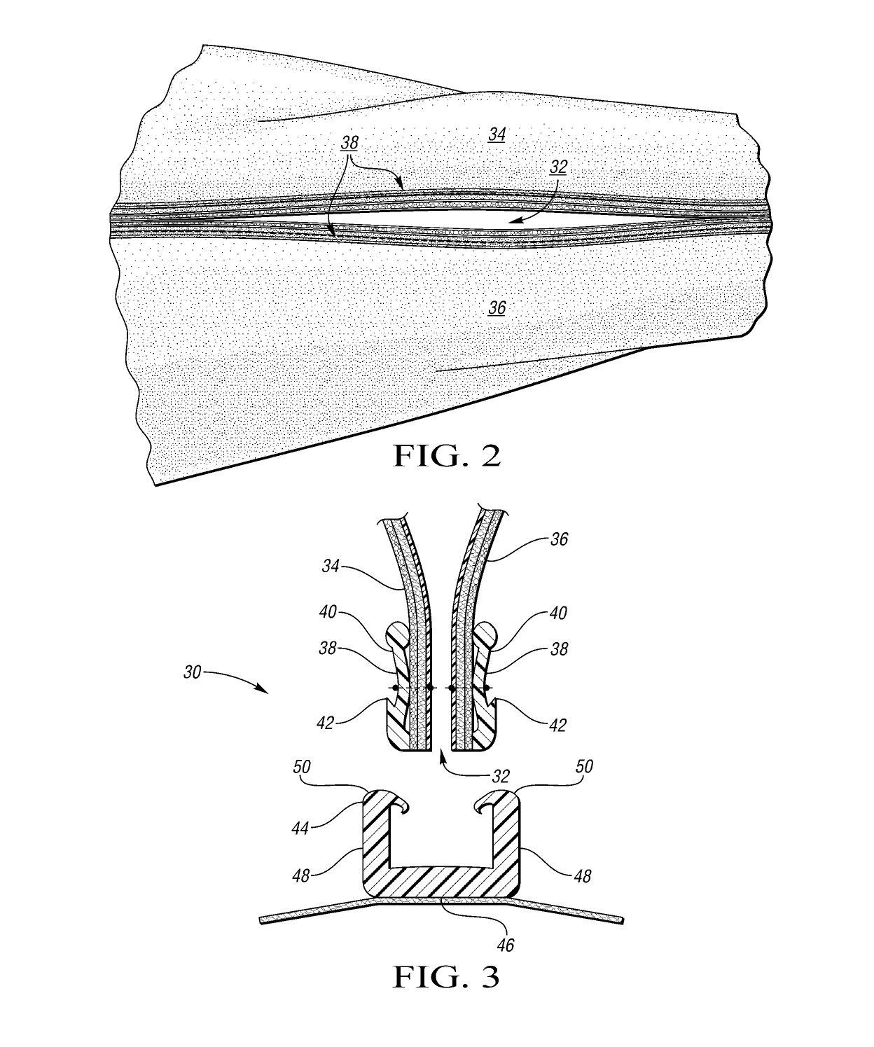

Referring now to FIGS. 2 and 3, the disclosed trim closeout slide system 30 may be employed to close an opening 32 between two adjacent trim panels 34, 36 to complete assembly of the trim cover on a vehicle seat. The openings may be defined at the edges of adjoining panels at particular locations to provide access to the interior of the seat assembly after the otherwise joined trim panels are positioned over the seat frame and cushions to aid in the installation of components (such as, for example, a side impact airbag module 18), or to otherwise aid in the completion of the assembly of the seat.

The disclosed system 30 includes first and second trim attachment elements which may be in the form of two resilient retainer strips 38. Each of the retainer strips 38 may include a substantially planar mounting surface 40 and an attachment portion, which may be in the form of an outwardly inclined arrow portion 42. The trim attachment elements may each be elongate members which, when secured to the edge of the trim panel, extend for substantially the entire length of the opening 32. The mounting surface 40 is sewn or otherwise securely attached to the edge of the trim panel on the interior surface of the panel over substantially the entire length of the opening 32, such that such that, when the edges at the opening of the two adjacent trim panels are positioned together for closure, the retainer strips are aligned side-by-side with the trim panel edges therebetween (as is best shown in FIG. 2). The attachment portion of the edge attachment elements may similarly extend along the attachment element for substantially the entire length of the attachment element. Alternatively, the attachment portion may be provided at intermittent locations along the length of the attachment element, if desired. As is best illustrated in FIG. 3, the arrow portion 42 of each of the retainer strips protrudes outward from and over the interior major surfaces of each of the trim panels when the edges of the trim panels are joined together to close the opening 32.

The trim closeout slide system 30 further includes an elongate closure element configured to extend over substantially the entire length of the opening. The closure element may be a resilient channel 44 which may be slidably positioned over the joined trim cover panel edges and retainer strips 38 to retain the trim panel edges and retainer strips together, thereby closing the opening between the panels and providing a smooth, finished seam between the panels (as shown in FIG. 5) similar to the sewn seams found elsewhere on the seat.

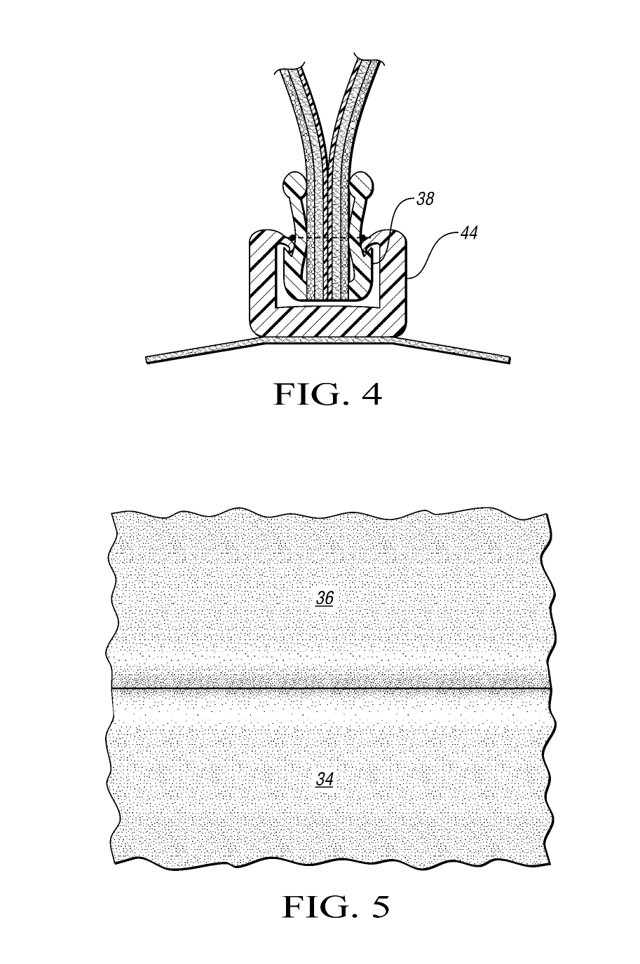

Referring now to FIG. 3, in this embodiment, the channel 44 includes a generally planar base portion 46 which is of sufficient width to accommodate the thickness of two retainer strips and two adjacent trim panel edges. The channel 44 further includes a pair of side walls 48 each of which extend substantially parallel to each other, and parallel to the major surfaces of the trim panels 34, 36. The upper portions 50 of the sidewalls of the channel are curled inward and downward (when viewed in cross-section, in the orientation shown in FIGS. 3 and 4), such that, when the channel is slidably positioned over the sandwich of the joined retainer strips and trim panel edges, the upper portions 50 extend inward and into the area between the mounting surface 40 and the arrow portion 42 of each of the retainer strips 38, thereby locking the retainer strips and trim cover panel edges together to close the opening between the trim panels.

The retainer strips 38 and the channel 44 may be fabricated of molded or extruded plastic or other similar flexible, resilient material. A fabric flashing 52 may be molded into the outer surface of the base portion 46 to provide a protective/insulative surface on the channel base, as well as a gripping surface to aid in installation.

It will be appreciated that the dimensions of the retainer strips 38 and channel 44 may be varied as required by the particular seat design, trim cover panel materials and thickness, and size of the opening. Similarly, the size and projection angle of the arrow portion of the retainer strips, as well as the inward and downward curvature of the channel may be varied to obtain the desired closure strength and seam appearance for a particular seat/trim design.

The disclosed seat trim closeout slide system thus provides a quick, easy-to-install, and removable closure. The channel 44 may be positioned by an assembler into the interior of the seat (through another access opening in the trim cover, not shown) and slidably positioned over the retainer strips to complete the closure of the seat trim panel opening (again, as shown in FIGS. 4 and 5) to thereby provide a smooth finished seam on the exterior surface of the seat.

It will be appreciated that the closeout system of the present invention may be utilized to close openings in trim cover panels on other vehicle components, such as headrests and side bolsters. It will be similarly appreciated that the closeout system may be utilized to close openings in other furniture or equipment that utilize similar multi-panel coverings.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A trim cover closeout system for securing adjoining trim cover portions on a vehicle component at an opening between the trim cover portions, the trim cover closeout system comprising:
a first trim edge attachment element including a mounting surface adapted to be secured at its proximal edge to the edge of one of the trim cover portions, and an attachment portion including an outwardly protruding surface;
a second trim edge attachment element including a mounting surface adapted to be secured at its proximal edge to the edge of a first trim cover portion, and an attachment portion including an outwardly protruding surface; and
an elongate closure element configured to extend over substantially the entire length of the opening and including at least one interference surface, wherein the closure element is adapted be slidably positioned over the distal edge of the attachment elements of both the first and second attachment elements and the at least one interference surface of the closure element interacts with at least one of the outwardly protruding surfaces of the first or second trim edge attachment elements to secure the first and second attachment elements and, thereby, the edges of the adjoining trim cover portions to each other.

2. The system of claim 1 wherein the attachment element is elongate and extends for substantially the entire length of the opening.

3. The system of claim 1 wherein the mounting surface is substantially planar and extends for substantially the entire length of the attachment element.

4. The system of claim 3 wherein the attachment portion extends for substantially the entire length of the attachment element.

5. The system of claim 3 wherein the attachment element includes a plurality of attachment portions which are located at spaced apart locations along the length of the attachment element.

6. The system of claim 1 wherein the closure element includes a channel including a generally planar base portion and a pair of opposed, spaced-apart, generally parallel sidewalls, each of said sidewalls extending in a generally transverse direction from the base portion at its proximal end, thereby forming a generally u-shaped cross-section, and wherein an interference surface is included on each of said sidewalls, each of which interference surfaces is formed as a second portion of the channel which extends inward from the sidewall at its distal end into the space between the pair of sidewalls.

7. The system of claim 6 wherein the channel extends for substantially the entire length of the closure element.

8. The system of claim 6 wherein the interference surfaces extend along each of the sidewalls of the channel for substantially the entire length of the channel.

9. The system of claim 6 wherein the closure element includes a plurality of interference surfaces which are located at spaced apart locations along the length of the channel.

10. A trim cover closeout system for securing adjoining trim cover portions on a vehicle seat at an opening between the trim cover portions, the trim cover closeout system comprising:
a first retainer strip including a substantially planar mounting surface adapted to be secured along the edge of a first trim cover portion, and an attachment portion including an outwardly protruding surface;
a second retainer strip including a substantially planar mounting surface adapted to be secured along the edge of a second trim cover portion, and an attachment portion including an outwardly protruding surface; and
a channel including a generally planar base portion and a pair of opposed, spaced-apart sidewalls, each of said sidewalls extending in a generally transverse direction from the base portion at its proximal end, thereby forming a generally u-shaped cross-section, and each of said sidewalls including a second portion which curls inward from the sidewall at its distal end into the space between the pair of sidewalls,
whereby the first and second retainer strips may be slidably positioned relative to the channel such that the first and second retainer strips and the trim cover edges to which the first and second retainer strips are attached are sandwiched between the sidewalls of the channel, the attachment portion of the first retainer strip interacts with the distal and of the first of one of the sidewalls, and the attachment portion of the second retainer strip interacts with the distal end of the other of said sidewalls to prevent removal of either of the trim cover edges from the channel, thereby securing the edges of the adjoining trim cover portions to each other.

11. The system of claim 10 wherein each of the first and second retainer strips are elongate and extend for substantially the entire length of the opening.

12. The system of claim 10 wherein the mounting surface on each of the retainer strips extends for substantially the entire length of the retainer strip.

13. The system of claim 10 wherein the attachment portion on each retainer strip extends for substantially the entire length of the retainer strip.

14. The system of claim 10 wherein each retainer strip includes a plurality of attachment portions which are located at spaced apart locations along the length of the retainer strip.

15. The system of claim 10 wherein the channel extends for substantially the entire length of the opening.

16. The system of claim 10 wherein the second portion on each side wall extends for substantially the entire length of the channel.

17. A vehicle seat assembly comprising:
a lower seat cushion assembly and a seat back cushion assembly each including one or more molded cushions and a rigid skeletal frame;
a trim cover comprising a number of trim panels each of which are joined together at one or more seems to form a smooth exterior covering for the vehicle seat, wherein prior to completion of assembly of the seat at least one opening is defined at the edges of adjoining trim panels; and
a trim cover closeout system for securing adjoining trim cover portions at the opening, the trim cover closeout system comprising,
a first retainer strip including a substantially planar mounting surface adapted to be secured along the edge of a first trim cover portion, and an attachment portion including an outwardly protruding surface,
a second retainer strip including a substantially planar mounting surface adapted to be secured along the edge of a second trim cover portion, and an attachment portion including an outwardly protruding surface, and
a channel including a generally planar base portion and a pair of opposed, spaced-apart sidewalls, each of said sidewalls extending in a generally transverse direction from the base portion at its proximal end, thereby forming a generally u-shaped cross-section, and each of said sidewalls including a second portion which curls inward from the sidewall at its distal end into the space between the pair of sidewalls, whereby the first and second retainer strips may be slidably positioned relative to the channel such that the first and second retainer strips and the trim cover edges to which the first and second retainer strips are attached are sandwiched between the sidewalls of the channel, the attachment portion of the first retainer strip interacts with the distal and of the first of one of the sidewalls, and the attachment portion of the second retainer strip interacts with the distal end of the other of said sidewalls to prevent removal of either of the trim cover edges from the channel, thereby securing the edges of the adjoining trim cover portions to each other.
